(19) United States
(12) Patent Application Publication
(10) Pub. No.: US 2025/0377170 A1
(43) Pub. Date: Dec. 11, 2025

(54) A DRAIN SYSTEM AND A SHOWER OR SHOWER CABIN

(71) Applicant: Enduce AB, UMEÅ (SE)

(72) Inventors: Henrik HAGMAN, UMEÅ (SE); Gustav Svenson, UMEÅ (SE); Thomas Holmberg, UMEÅ (SE)

(73) Assignee: Enduce AB, UMEÅ (SE)

(21) Appl. No.: 18/875,970

(22) PCT Filed: Jun. 26, 2023
(86) PCT No.: PCT/EP2023/067331

§ 371 Date: Dec. 17, 2024

(30) Foreign Application Priority Data
Jul. 1, 2022 (SE) 2250831-1

(51) Int. Cl. F28D 21/00; B01D 29/01; B01D 29/44; B01D 29/56; B01D 36/02; B01D 36/04; E03C 1/264

(52) U.S. Cl. CPC F28D 21/0012; B01D 29/018; B01D 29/44; B01D 29/56; B01D 36/02; B01D 36/04; E03C 1/264

(57) ABSTRACT

The present invention relates to a drain system for recovering thermal energy from a flow of shower or faucet greywater. The drain system comprises: a drain collector having a receiving surface for receiving greywater, and a drain collector outlet formed in the receiving surface for discharging greywater from the receiving surface; a heat exchanger configured to heat a flow of incoming cold water with the greywater; an upstream filter and a downstream filter, arranged to filter the greywater flowing along the receiving surface to the drain collector outlet, wherein the upstream filter comprises a first filter screen protruding from the receiving surface and the downstream filter comprises a second filter screen arranged upstream the drain collector outlet.

### FIELD OF THE INVENTION

The present invention relates to drain systems for recovering thermal energy from a flow of greywater. The present invention also relates to showers or shower cabins comprising such drain systems.

### BACKGROUND OF THE INVENTION

A shower typically comprises a shower head fluidly connected to a shower mixer configured to mix hot water from a hot water supply and cold water from a cold water supply. The hot water supply may e.g. be water heated by a domestic boiler (using a combustible fuel, electricity, district heating, or a heat pump). Thus, showers are energy intensive units, consuming a lot of energy to heat the hot water used for showering.

Devices which recover heat from the shower greywater (i.e. the wastewater discharged from a shower floor into a shower drain system) are known from the prior art, e.g. from GB2232749, U.S. Pat. No. 4,619,311, GB2052698 and DE29615555. Such devices are typically installed in the shower drain system to recover heat from the shower greywater, for example from a shower tray, using a plate heat exchanger with a high thermal efficiency. However, since the heat exchanger, and the shower drain system, are prone to fouling, e.g. caused by fatty deposits, hair products like conditioners, and debris such as hair or textile fibers in the shower greywater, the shower greywater system will get blocked and/or the efficiency of the heat exchanger reduced over time. The more heat energy the heat exchanger recycles, i.e. removes from the shower greywater, the more prone it is to fouling as the removal of thermal energy results in solidification of e.g. grease and waxes. Thus, cleaning of heat recycling shower drain system is crucial.

Cleaning of the shower drain system, and the heat exchanger in particular, is time consuming, cumbersome, may expose the user to detergents, and is often perceived as disgusting. Thus, there is a need in the industry for an improved shower drain system.

### SUMMARY

An object of the invention is to overcome the above problems, and to provide a drain system for recovering thermal energy from a flow of shower or faucet greywater which is improved compared to prior art solutions, by providing a configuration enabling efficient and easily maintained filtering of the grey water. In particular, the effective filtering is achieved upstream of a heat exchanger of the drain system. Hereby, problems related to fouling, drain blockage, or partial drain blockage, caused by deposited grease, shower products and/or debris and hair in the greywater may be reduced or even avoided. Thus, the thermal energy recovering of the system may be improved. Moreover, the drain system of the present invention is relatively simple, cost efficient and user-friendly. This, and other objects, which will become apparent in the following, are accomplished by means of a drain system, and a shower or shower cabin comprising such drain system.

The present invention is based on the insight that efficient filtering of the grey water can be achieved by providing an upstream filter and a downstream filter, through which the greywater passes, prior to reaching the heat exchanger of the system. Moreover, by arranging at least two filters at a drain collector having a receiving surface for receiving the greywater, i.e. prior to that the grey water passes through a drain collector outlet and further into the drain system towards the heat exchanger, easy and effective cleaning of the system can be performed as the debris is filtered early (i.e. high upstream) in the drain system. Moreover, as the filters are arranged upstream of the drain collector outlet, and thus arranged above the continuously wetted sections of the drain system, biological growth in filter and filter reject can be reduced.

According to at least a first aspect of the present invention, a drain system for recovering thermal energy from a flow of shower or faucet greywater is provided. The system comprises:
a drain collector having a receiving surface for receiving greywater, and a drain collector outlet formed in the receiving surface for discharging greywater from the receiving surface,
a heat exchanger arranged downstream of the drain collector outlet and comprising a grey water inlet and grey water outlet, the heat exchanger being configured to heat a flow of incoming cold water with the greywater flowing from the grey water inlet to the grey water outlet,
an upstream filter and a downstream filter, arranged to filter the greywater flowing along the receiving surface to the drain collector outlet, wherein the upstream filter comprises a first filter screen protruding from the receiving surface and the downstream filter comprises a second filter screen arranged upstream the drain collector outlet.

Hereby, an improved drain system is provided including efficient filtering of the grey water. Thus, debris, such as textile fibers and hair, may be at least partly prevented from entering the drain collector outlet and the heat exchanger. The upstream and downstream filters are arranged such that, during use, the greywater flowing over the receiving surface first encounters the upstream filter, is filtered by the upstream filter, and then passes to the downstream filter, is filtered by the downstream filter, and then passed to the drain collector outlet and further to the heat exchanger. The upstream filter and the downstream filter may thus be referred to as being subsequently arranged, and being arranged to filter the greywater prior to reaching the heat exchanger. By filtering the greywater by the two subsequently arranged upstream and downstream filters, an additive filtering effect of the greywater is achieved. For example, if the upstream filter has a filtering performance of 60% (i.e. 60% of the debris is caught in the upstream filter and 40% of the debris passes the upstream filter; 60% e.g. be based on weight) and the downstream filter has a filtering performance of 70%, the overall filtering performance of the upstream and downstream filters is 1−(0.30*0.40) equally to 0.88, i.e. 88%. Thus, by providing multiple filters, each having a relatively low filtering performance, and arranging them as subsequently arranged upstream filter and downstream filter, the overall filtering performance increases exponentially to become relatively high. As the upstream filter and the downstream filter are arranged upstream of the drain collector outlet, easy and effective cleaning of the drains system can be performed as the debris is filtered upstream of the drain collector outlet. The drain collector outlet is typically connected to the grey water inlet of the heat exchanger by means of a connecting conduit. Thus, the debris is filtered upstream of such connecting conduit and upstream of the heat exchanger.

According to at least one example embodiment, the first filter screen protrudes, or extends, outwards from the receiving surface, such as e.g. in a direction along a geometrical normal to the receiving surface, or slightly inclined relative to such geometrical normal (e.g. by up to +/−) 30°.

According to at least one example embodiment, the receiving surface is a horizontally arranged surface, or a substantially horizontally arranged surface. The receiving surface may be slightly inclined from an outer periphery to a center of the receiving surface (e.g. inclined by up to +/−15° relative a horizontal plane). Typically, the drain collector outlet is arranged in the center of the receiving surface. The drain collector outlet is typically arranged to provide a flow section of the greywater in a perpendicular direction relative to the receiving surface. Thus, as the receiving surface is typically arranged to provide a flow section for the greywater along the receiving surface in a horizontal or substantially horizontal direction, the flow direction of the grey water will, during use, change from a horizontal, or substantially horizontal direction to a vertical, or substantially vertical direction in the drain collector outlet. As mentioned earlier, the drain collector outlet may be coupled to the grey water inlet of the heat exchanger by means of a connecting conduit. The connecting conduit may comprise a drain cup, or a drain cup portion. Typically, the drain cup, or drain cup portion is arranged vertically below the drain collector outlet.

According to at least one example embodiment, the second filter screen of the downstream filter is a mesh covering the drain collector outlet.

Hereby, an improved filtering performance is achieved. Hereby, debris may be at least partly prevented from entering the drain collector outlet and the heat exchanger. The mesh may be referred to as a strainer. The mesh size of the second filter screen is e.g. between 0.5 mm and 4 mm, such as between 1 mm and 2.5 mm.

According to at least one example embodiment, the second filter screen is a bowl-, cone- or pocket shaped mesh. In other words, the mesh may be bent, or be cup-shaped. The shape of the mesh may be concave or convex, i.e. bent downwards or bent upwards. According to at least one example embodiment, the first filter screen is half-spherical.

According to at least one example embodiment, the drain system further comprises an intermediate filter arranged downstream of the upstream filter and upstream of the downstream filter, the intermediate filter comprising a third filter screen protruding from the receiving surface correspondingly to the first filter screen of the upstream filter.

Hereby, the filtering performance of the drain system is further improved. The third filter screen may e.g. be arranged to protrude from the receiving surface in a corresponding manner as the first filter screen. Thus, the third filter screen may protrude, or extend, outwards from the receiving surface, such as e.g. in a direction along a geometrical normal to the receiving surface, or slightly inclined relative to such geometrical normal (e.g. by up to +/−) 30°. The third filter screen may be arranged closer to the drain collector outlet compared to the first filter screen. That is, for corresponding sections of the first and third filter screens, the third filter screen is arranged closer to the drain collector outlet as compared to the first filter screen. Typically, the upstream filter, the intermediate filter and the downstream filter are subsequently arranged. Thus, during use, greywater first passes the upstream filter, then the intermediate filter, and subsequently the downstream filter.

According to at least one example embodiment, the first filter screen of the upstream filter is arranged to encompass the drain collector outlet and the downstream filter.

Thus, a simply yet effective structure of the first filter screen to ensure that all greywater passing to the drain collector outlet is filtered by the upstream filter is provided.

According to at least one example embodiment, the first filter screen of the upstream filter is encompassing the third filter screen of the intermediate filter.

Thus, a simply yet effective structure of the first filter screen to ensure that all greywater passing to the third filter screen of the intermediate filter is first filtered by the upstream filter is provided. The third filter screen of the intermediate filter may be arranged to encompass the drain collector outlet and the downstream filter. Thus, a simply yet effective structure of the third filter screen to ensure that all greywater passing to the drain collector outlet is filtered by the intermediate filter is provided.

According to at least one example embodiment, each one of the first and third filter screens is shaped as an elliptical ring, or an annular ring.

Hereby, a simply yet effective structure of the first filter screen and the third filter screen to ensure that all greywater passing to the drain collector outlet is passing the upstream filter and the intermediate filter is provided. In other words, the first filter screen may be shaped as an encircling, or encompassing, filter wall surrounding the intermediate filter and the drain collector outlet. Such filter wall may thus be circularly shaped or be shaped as an oval. However, such filter wall may alternatively be rectangularly shaped. Correspondingly, the third filter screen may be shaped as an encircling, or encompassing, filter wall surrounding the drain collector outlet. Such filter wall may thus be circularly shaped or be shaped as an oval, but may as well be rectangularly shaped. Thus, the upstream filter and the intermediate filter may be shaped as encircling, or encompassing, filter walls surrounding the drain collector outlet.

According to at least one example embodiment, the upstream filter and the downstream filter are arranged to filter all, or subsequently all, of the greywater flowing along the receiving surface.

However, as will be described later in the text, the upstream filter may comprise at least two first filter sub-screens, e.g. arranged in parallel or opposite each other. That is, the upstream filter may be comprised of at least two separate parts, wherein the first filter screen is a first filter sub-screen, and the upstream filter further comprises a second filter sub-screen. The first filter sub-screen may be connected to the second filter sub-screen by means of walls, such as non-filtering walls. For example, the drain collector may be arranged to receive the greywater from two different, preferably opposite, directions, and be configured to guide the greywater towards the drain collector outlet by means of two separate guide portions, or guide channels, of the receiving surface. Thus, one of the two filter sub-screens of the upstream filter may be arranged in a first of the two guide portions, and the other one of the two filter sub-screens of the upstream filter may be arranged in a second of the two guide portions. Thus, all greywater flowing over the receiving surface is filtered by the upstream filter, but by means of separate filter sub-screens in the separate guide portions. Obviously, the upstream filter may comprise more than two filter sub-screens, and the drain collector may be arranged to guide the greywater towards the drain collector outlet by means of more than two separate guide portions. According to at least one example embodiment, the intermediate filter comprises at least two third filter sub-screens, e.g. arranged in parallel or opposite each other, in a corresponding manner as for the upstream filter.

According to at least one example embodiment, the first filter screen of the upstream filter has an outer side facing upstream to receive greywater, and an opposite inner side facing downstream.

That is the first filter screen is shaped as a filter wall protruding from the receiving surface and having an outer side, or a first side, facing upstream to receive greywater, and an opposite inner side, or second side, facing downstream. Thus, for embodiments with the intermediate filter, the inner side faces the third filter screen. Correspondingly, the third filter screen of the intermediate filter has an outer side facing the upstream filter, and an opposite inner side facing downstream. That is the third filter screen may be shaped as a filter wall protruding from the receiving surface and having an outer side, or a first side, facing upstream and the inner side of the first filter screen, and an opposite inner side, or second side, facing downstream.

According to at least one example embodiment, the upstream filter and the downstream filter has different filtering performances.

For example, one of the upstream and downstream filters has a relatively low filtering performance, and the other one of the upstream and downstream filters has a relatively high filtering performance. By having different filtering performances of the upstream and downstream filters, the drain system is made more robust, and less sensitive to clogging. The filtering performance of a filter is characterized by its filtration efficiency, i.e. its ability to separate particles and/or debris from the greywater.

According to at least one example embodiment, the intermediate filter has a different filtering performance relative to at least one of the upstream and downstream filters. For example, the filtering performance of the upstream filter and the intermediate filter is the same, or substantially the same.

According to at least one example embodiment, the upstream filter and the downstream filter has different filtering capacities. The filtering capacity of a filter is e.g. related to the flow of greywater which the filter can handle.

According to at least one example embodiment, the upstream filter is a slit filter.

Thus, the first filter screen may comprise slits through which the greywater may pass, and posts arranged adjacent the slits for hindering greywater debris. Hereby, debris may be caught at the posts, or at the interface between the posts and the slits. The slit gap of the first filter screen may e.g. be between 1 mm and 5 mm. The slit gap may be defined as the shortest distance between two adjacent posts. According to at least one example embodiment, each slit has a width and a length forming a slit cross section, wherein the length is at least twice that of the width.

According to at least one example embodiment, the intermediate filter is a slit filter.

Thus, the third filter screen may comprise slits through which the greywater may pass, and posts arranged adjacent the slits for hindering greywater. Hereby, debris may be caught at the posts, or at the interface between the posts and the slits. The slit gap of the third filter screen may e.g. be between 1 mm and 5 mm.

According to at least one example embodiment, the slit gap of the third filter screen is smaller than the slit gap of the first filter screen. Hereby, efficient filtering of the greywater is achieved.

The posts in between the slits of the first filter screen and/or the third filter screen may be tapering, or be conically shaped. Hereby, the strength of the posts is improved, and the posts are less prone to breaking. Additionally, or alternatively, the height of the slits of the first filter screen and/or the third filter screen extends along at least a majority of the height of the respective filter screen. According to at least one example embodiment, the height of the slits of the first filter screen and/or the third filter screen extends along the entire height of the respective filter screen.

According to at least one example embodiment, the posts of the slit filter may be referred to as pins or teeth. Thus, the slits are the gaps between the pins or teeth.

According to at least one example embodiment, each one of the first and third filter screens may comprise multiple random or sig-sag arranged vertical pins or teeth protruding from the receiving surface. Hereby, the filter screen comprises multiple layers along the width of the filter screen for further improving the filtering performance. As a further alternative, the posts of the slit filter of the first filter screen and/or the third filter screen are horizontally arranged. For example, the first filter screen and/or the third filter screen may comprise a frame, or frame-like structure from which the horizontally arranged posts extend. Hereby, the slits are formed as gaps between the horizontally arranged posts.

According to at least one example embodiment, the first filter screen and/or the third filter screen comprises holes, or apertures, through which the greywater may pass. The holes or apertures may e.g. be rectangularly shaped.

According to at least one example embodiment, the drain system comprises a vertical step-wise structure protruding upwards from the receiving surface and being arranged downstream of the upstream filter and upstream of the downstream filter to form a sand trap.

That is, the step-wise structure, or the step, is formed as a sand trap at which sand, or other heavy particles may be trapped before the grey water enters the heat exchanger. As an alternative, the sand trap may be arranged as a ditch, or indentation in the receiving surface.

According to at least one example embodiment, the receiving surface comprises a first surface portion arranged laterally outside of the upstream filter, and a second surface portion arranged at least laterally inside of the upstream filter, wherein the upstream filter and the downstream filter are attached to the second surface portion and are removably arranged relative to the first surface portion.

Hereby, easy and effective cleaning of the system can be performed as the upstream and downstream filters can be removed together with the second surface portion of the receiving surface in order to remove any debris which has been caught by the upstream and downstream filters. Thus, the second surface portion is removably arranged relative to the first surface portion. According to at least one example embodiment, the intermediate filter is also attached to the second surface portion and is thus removably arranged relative to the first surface portion together with the upstream and downstream filters.

According to at least one example embodiment, a rim of the second surface portion extends laterally outside from the upstream filter, the rim being arranged to extend along the upstream filter.

Hereby, any debris which has been caught by the first filter screen, and which is at least partly stuck to/at the previously mentioned outer side of the first filter screen, may rest on the rim and thus be removed together with the second surface portion. Hereby, the risk that debris is left at the first surface portion of the receiving surface as the second surface portion together with the upstream and downstream filters is removed is reduced.

According to at least one example embodiment, the drain system is a shower drain system.

According to at least one example embodiment, the drain system further comprises a perforated plate comprising the second filter screen, the perforated plate comprising a plurality of perforations for guiding the first filter screen.

Thus, the perforations allow for the perforated plate to move relative to the first filter screen. Hereby, any debris attached to the first filter screen may adhere to the perforated plate as it is moved relative to the first filter screen, and thereby, the debris may more easily be removed. Moreover, as the perforated plate comprises the second filter screen, any debris caught by the second filter screen may be removed together with the debris from the first filter screen. As previously mentioned, the second filter screen is preferably a mesh.

According to at least on example embodiment, the receiving surface comprises a first surface portion from which the first filter screen protrudes, and a second surface portion formed by the perforated plate and being removably arranged on top of the first surface portion.

That is, instead of the previously mentioned embodiment in which the upstream filter and the downstream filter are attached to the second surface portion of the receiving surface (and are removably arranged relative to the first surface portion), the first filter screen (or the posts of the first filter screen) is attached to the first surface portion of the receiving surface from which it protrudes, and the second filter screen is attached to the second surface portion. Thus, as the second surface portion of the receiving surface, i.e. the perforated plate, is removably attached to the first surface portion, the perforated plate may be removed from the first surface portion for facilitated removal of debris, as previously described.

The first filter screen may be described as protruding from the first surface portion of the receiving surface and through the perforated plate. Hereby, the greywater may flow along the first surface portion and further to the second surface portion or the perforated plate and be filtered by the first filter screen prior to reaching the second filter screen of the perforated plate. After being filtered by the second filter screen, the greywater reached the drain collector outlet.

According to at least one example embodiment, the perforated plate extends from laterally outside of the upstream filter and towards the drain collector outlet. For example, the perforated plate extends from just outside the upstream filter and up to the drain collector outlet. For example, the perforated plate extends from the plurality of apertures up to the drain collector outlet.

According to at least one example embodiment, the perforated plate is configured to be moved from a first position in which the perforated plate rests on the first surface portion of the receiving surface, into a second position in which the perforated plate is vertically distant from the first surface portion of the receiving surface by a predetermined distance. Hereby, debris may be efficiently removed from the perforated plate. That is, in the second position of the perforated plate, the perforated plate is vertically distant from the first surface portion of the receiving surface and therefore more accessible for cleaning. Moreover, as previously mentioned, debris attached to the first filter screen may adhere to the perforated plate, and as it is vertically moved to the second position, the debris may be efficiently removed. It should be understood that during normal use of the drain system, i.e. as the greywater is filtered on its way to the drain collector outlet, the perforated plate is arranged in its first position. The first position may be referred to as a lower position, or relatively low position, and the second position may be referred to as an upper position, or relatively high position. The upper, or second position, is arranged vertically above the lower, or first position.

According to at least one example embodiment, the first filter screen is a slit filter comprising a plurality of posts in between the slits, wherein each perforation in the plurality of perforations is configured to guide a corresponding post of the slit filter. Hereby, the perforate plate can be moved relative to the first filter screen in an advantageous manner. Thus, it should be understood that as the perforate plate is moved relative to the first filter screen, the posts of the slit filter run, or protrude, through the perforations of the perforate plate.

As previously mentioned, the slits of the slit filter are configured to allow the greywater to pass, and the posts are arranged adjacent the slits for hindering greywater debris. Hereby, debris may be caught at the posts, or at the interface between the posts and the slits. The slit gap of the first filter screen may e.g. be between 1 mm and 5 mm. The slit gap may be defined as the shortest distance between two adjacent posts. According to at least one example embodiment, each slit has a width and a length forming a slit cross section, wherein the length is at least twice that of the width

According to at least one example embodiment, the plurality of posts has a predetermined height, wherein the predetermined distance is at least the same as the predetermined height. Hereby, in the second position of the perforated plate, the posts will not protrude through the perforations, thereby achieving an upper surface of the perforated plate which is easy to clean.

According to at least one example embodiment, the drain system further comprises a first locking structure, wherein the perforated plate comprises a second locking structure, and wherein the perforated plate is configured to be locked in the second position by that the second locking structure lock to the first locking structure. Hereby, the perforated plate may be locked in the second position facilitating cleaning of the upper surface of the perforated plate.

According to at least one example embodiment, the perforated plate comprises a ridge-like structure extending along a length of the perforated plate, and an opening arranged along the ridge-like structure, wherein the opening is aligned with the drain collector outlet. Hereby, the drain collector outlet may be accessed in an advantageous manner.

According to at least one example embodiment, the ridge-like structure comprises a vertically arranged mesh or grid arranged upstream of the drain collector outlet. Thus, the vertically arranged mesh or grid may in a greywater fluid flow perspective be arranged parallel to the second filter screen.

According to at least one example embodiment, the ridge-like structure forms a handle which may be gripped by a user when moving the perforated plate, e.g. to the second position.

According to at least one example embodiment, the opening is defined by inner walls extending into the ridge-like structure. Opposite the opening, inside the ridge-like structure, a grating may be attached to the inner walls upstream of the drain collector outlet. Hereby, a cleaning material can easily be filled into opening and held in position by the grating and the inner walls.

According to at least one example embodiment, the opening is arranged vertically at the same level or above the vertical level of the previously mentioned alternative drain inlet.

According to at least one example embodiment, the drain system comprises an alternative drain inlet fluidly coupled to a by-pass conduit arranged to by-pass the heat exchanger. Hereby, greywater can instead of, or in addition to, be guided via the drain collector outlet and the heat exchanger, be guided via the alternative drain inlet to by-pass the upstream and downstream filters (as well as any intermediate filter). The by-pass conduit may be arranged to supply the greywater from the alternative drain inlet to the sewer downstream of the heat exchanger, or to a greywater collector arranged downstream of the heat exchanger but upstream of the sewer. Thus, in case of flooding, or in order to handle a flow of greywater exceeding the capacity of the heat exchanger, the drain system is configured to guide the greywater to the sewer (or greywater collector) via the by-pass conduit and the alternative drain inlet.

According to at least one example embodiment, the first filter screen of the upstream filter, and optionally the third filter screen of the intermediate filter, extend vertically to the same level or above the vertical level of the alternative drain inlet. The inlet to the alternative drain inlet may be arranged in a protruding pipe extending vertically from the receiving surface, or the drain collector. In other words, the height of the first filter screen, and possibly the third filter screen, is as large, or larger than, the height of the vertically protruding pipe comprising the alternative drain inlet. Hence, in case of flooding, or in order to handle a flow of greywater exceeding the capacity of the heat exchanger, the greywater is guided to the sewer (or greywater collector) via the by-pass conduit and the alternative drain inlet, while ensuring that no or a limited amount of unfiltered greywater is passed to the drain collector outlet without passing at least the upstream filter. That is, in case of flooding, unfiltered greywater cannot pass over the first filter screen, and the optional third filter screen, in an amount that can block the heat exchanger, but will instead be guided to the alternative drain inlet and the by-pass conduit.

According to at least one example embodiment, the perforated plate comprises a sand trap, e.g. the previously described sand trap. The sand trap may be a vertical step-wise structure protruding inwards or upwards from the second surface portion of the receiving surface, and being arranged downstream of the upstream filter and upstream of the downstream filter.

According to a second aspect of the present invention, a drain system for recovering thermal energy from a flow of shower or faucet greywater is provided. The drain system comprising:
a drain collector having a receiving surface for receiving greywater, and a drain collector outlet formed in the receiving surface for discharging greywater from the receiving surface,
a heat exchanger arranged downstream of the drain collector outlet and comprising a grey water inlet and grey water outlet, the heat exchanger being configured to heat a flow of incoming cold water with the greywater flowing from the grey water inlet to the grey water outlet,
an upstream filter being a first filter screen and a downstream filter being a second filter screen, both the upstream filter and the downstream filter being arranged to filter the greywater flowing from the receiving surface to the drain collector outlet,
wherein the drain system further comprises a perforated plate comprising the second filter screen, the perforated plate comprising a plurality of perforations for guiding the first filter screen.

Effects and features of the second aspect of the invention are largely analogous to those described above in connection with the perforated plate of the first aspect of the invention. Embodiments mentioned in relation to the perforated plate in the first aspect of the invention are largely compatible with the second aspect of the invention, of which some are exemplified below.

As mentioned in the first aspect of the invention, the second filter screen is preferably a mesh, and the first filter screen is preferably a slit filter comprising a plurality of posts in between the slits, wherein each perforation in the plurality of perforations is configured to guide a corresponding post of the slit filter. The post of the slit filter typically protrudes from the drain collector and hence, the perforate plate may be moved, or lifted, from the drain collector to a position (e.g. the second position described with reference to the first aspect) in which the perforated plate is easily cleaned. Thus, as the perforations is configured to guide a corresponding post of the slit filter, the posts will be cleaned by the perforated plate as the perforated plate is moved relative to the first filter screen.

According to a third aspect of the present invention, a shower or shower cabin is provided. The shower or shower cabin comprises:
a shower arrangement having a shower mixer configured to mix hot water from a hot water supply and pre-heated cold water from a cold water supply, and a shower head fluidly connected to the shower mixer for supplying shower water;
a drain system according to the first aspect of the invention or the second aspect of the invention.

Effects and features of the third aspect of the invention are largely analogous to those described above in connection with the first and second aspects of the invention. Embodiments mentioned in relation to the first and second aspects of the invention are largely compatible with the third aspect of the invention, of which some are exemplified below.

The shower or shower cabin may comprise a shower floor or a shower tray, or alternatively be replaced with a shower tray (i.e. a shower cabin without the enclosing walls). The receiving surface of the drain system is typically forming a surface of the shower floor or shower tray, or is arranged in the shower floor or shower tray. For example, the receiving surface may be arranged in a pocket of the shower floor or shower tray, wherein the pocket is covered with a plate, and wherein the plate is provided with at least one opening (or strainer or grating) enabling greywater therethrough and further onto the receiving surface.

According to at least one example embodiment, the heat exchanger of the drain system is configured to heat a flow of incoming cold water with the greywater flowing from the grey water inlet to the grey water outlet, to provide the cold water as the pre-heated cold water of the shower arrangement.

Thus, the drain system is arranged and configured to pre-heat the cold water from a cold water supply prior to that the cold water (or pre-heated cold water) is supplied to the shower mixer. The cold water may e.g. be tap water. Thus, the drain system may be connectable to a tap water supply.

According to a fourth aspect of the present invention, a drain system for recovering thermal energy from a flow of shower or faucet greywater is provided. The system comprises:
a drain collector having a receiving surface for receiving greywater, and a drain collector outlet formed in the receiving surface for discharging greywater from the receiving surface,
a heat exchanger arranged downstream of the drain collector outlet and comprising a grey water inlet and grey water outlet, the heat exchanger being configured to heat a flow of incoming cold water with the greywater flowing from the grey water inlet to the grey water outlet,
a plate covering the drain collector,
an upstream filter and a downstream filter, arranged to filter the greywater flowing along the receiving surface to the drain collector outlet, wherein the upstream filter comprises a first filter screen protruding from the plate towards the receiving surface and the downstream filter comprises a second filter screen arranged upstream the drain collector outlet.

Effects and features of the fourth aspect of the invention are largely analogous to those described above in connection with the first to third aspects of the invention. Embodiments mentioned in relation to the first to third aspects of the invention are largely compatible with the fourth aspect of the invention.

The drain system may be configured for being arranged in a pocket in the shower floor. Thus, when the drain system is arranged in such pocket, the plate (or lid) constitutes a portion of the shower floor. The plate may be provided with at least one opening for passing water through to the receiving surface. The at least one opening may e.g. be covered with the first filter screen. Alternatively, an opening for passing water through to the receiving surface is formed by a gap between the drain collector and the plate. Here, the first filter screen may protrude from the plate to cover the gap.

Applicable to both the first, second, third and fourths aspects of the invention, it should be noted that the heat exchanger of the drain system may be configured to preheat incoming cold water to a mixer of the shower or faucet. However, according to at least one example embodiment, the heat exchanger of the drain system is configured to preheat incoming cold water in part, or completely, to a water heater, such an externally arranged water heater (i.e. externally arranged relatively to the drain system), or an instant heater. Thus, the preheated cold water may be partly or completely routed to a water heater, resulting in an increased flow of cold water through the heat exchanger and thereby increasing the heat recovery from the grey water compared to if the cold water through the heat exchanger was only supplied to the shower mixer. The heat exchanger is typically arranged to discharge the greywater downstream to e.g. a sewer. Also applicable to the first, second, third and fourth aspects of the invention, the heat exchanger is preferably a plate heat exchanger.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates a shower or shower cabin comprising a drain system for recovering thermal energy from a flow of greywater, in accordance with at least some example embodiments of the invention;

FIG. 2 illustrates the drain system of FIG. 1 in more detail, and according to at least one example embodiment of the invention,

FIG. 3 illustrates a drain collector of the drain system of FIG. 2 in more detail, and according to at least one example embodiment of the invention,

FIG. 4 illustrates a filter arrangement of an upstream filter, an intermediate filter and a downstream filter of FIG. 3 in more detail, and according to at least one example embodiment of the invention,

FIG. 5 illustrates an alternative drain collector of the drain system of FIG. 2, and according to at least one example embodiment of the invention, and,

FIGS. 6-7 illustrate a part of drain collector and a filtering arrangement according to at least one example embodiment of the invention.

### DETAILED DESCRIPTION OF EXAMPLE EMBODIMENTS

In the present detailed description, various embodiments of the invention are described mainly with reference to a shower (or shower cabin) comprising a drain system for recovering thermal energy from a flow of greywater

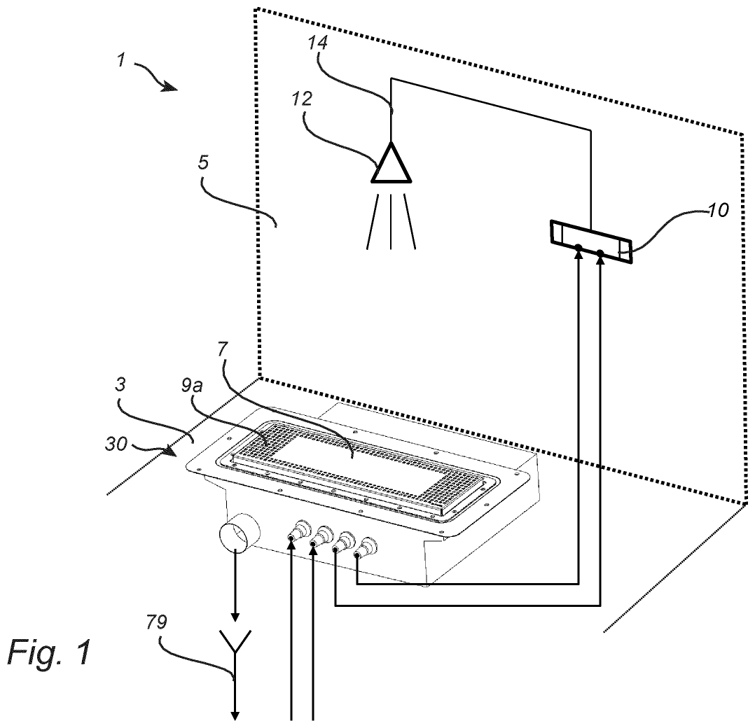

FIG. 1 is a schematic view illustrating a shower or shower cabin 1. The shower or shower cabin 1 comprises a shower tray or shower floor 3, and shower walls 5 (of which only one shower wall is shown). The shower walls 5 are either attached to the building in which the shower 1 is installed, or are separated from the building and thus forming part of a shower cabin 1. Correspondingly, the shower tray or floor 3 is either attached to the building (i.e. constituting a shower floor of a shower), or is separated from the building (i.e. constituting a shower tray of a shower cabin). For simplicity, the shower or shower cabin 1 will in the following be described simply as a shower 1, and the shower tray or floor 3, as a shower floor 3.

The shower 1 further comprises a shower mixer 10 and a shower head 12, the shower head 12 being fluidly connected to the shower mixer 10 by a shower conduit 14, being for example a shower hose or shower pipe. The shower mixer 10 is configured to mix hot water from a hot water supply, e.g. a hot tap water supply, and pre-heated cold water from a cold water supply, the latter being pre-heated cold water from a heat exchanger in the drain system 30 as will be described in the following. During use, the shower mixer 10 mixes the desired amount of pre-heated cold water and hot water, supplies the mixed water to the shower head 12 via the shower conduit 14, whereby shower water for showering is provided. The shower water subsequently encounters the shower floor 3, and enters the shower drain system 30 as greywater. The greywater typically comprises debris, such as textile fibers and hair, as well as grease and shower products, as a result of the showering.

In the embodiment of FIG. 1, the drain system 30 is arranged in a pocket of the shower floor 3, wherein the pocket is covered with a plate 7, and wherein the plate 7 is provided with at least one opening, here being in the form of a plurality of punched holes 9a. However, it should be noted that the at least one opening may instead of a plurality of punched holes 9a be comprised of one or more gaps in the plate 7, e.g. one or more gaps arranged on one or more of the lateral sides of the plate 7. Thus, the greywater may enter the drain system 30 via the punched holes 9a.

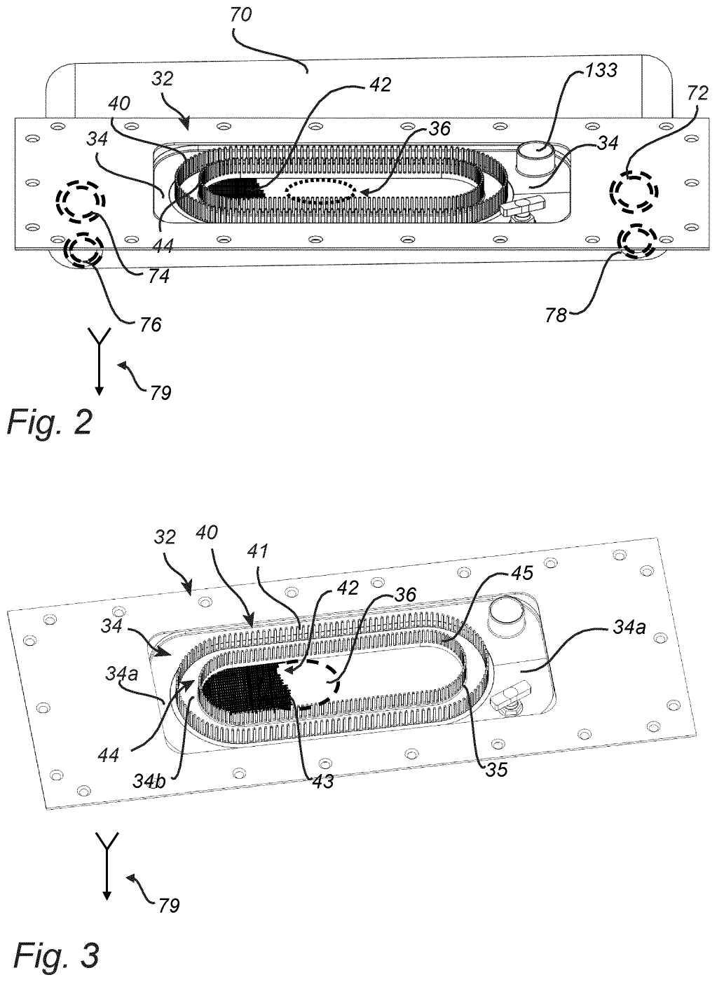

In the following, the drain system 30 will be described in further detail with additional reference to FIG. 2, in which the plate 7 has been removed for increased comprehensibility. The drain system 30 comprises a drain collector 32 having a receiving surface 34 for receiving greywater via the punched holes 9a (shown in FIG. 1). The drain collector further comprises a drain collector outlet 36 (shown partly hidden) formed in the receiving surface 34 for discharging greywater from the receiving surface 34, and further downstream into the drain system 30.

The drain system 30 further comprises a heat exchanger 70, shown partly hidden behind the drain collector 32. The heat exchanger 70 is arranged downstream of the drain collector outlet 36 and comprises a grey water inlet 72 and grey water outlet 74. Moreover, the heat exchanger 70 comprises a cold water inlet 76 for receiving cold water from a cold water supply and a cold water outlet 78 for discharging the pre-heated cold water to the shower mixer 10. The grey water inlet 72, grey water outlet 74, cold water inlet 76 and the cold water outlet 78 are shown in dashed as they partly concealed behind the drain collector 32. However, it should be noted that the pre-heated cold water may additionally or alternatively be supplied to a water heater or instant heater. The heat exchanger 70 is thus configured to heat a flow of incoming cold water with the greywater flowing from the grey water inlet 72 to the grey water outlet 74. In FIG. 2, the heat exchanger 70 is a plate heat exchanger comprising heat exchanging surfaces arranged and configured to transfer heat from the greywater to the incoming cold water. The heat exchanger is typically arranged to discharge the greywater from the grey water outlet 74 downstream to e.g. a sewer 79 (shown symbolically in some of the figures).

The drain system 30 further comprises an upstream filter 40 and a downstream filter 42 arranged downstream of the upstream filter 40. The drain system 30 further comprises an optional intermediate filter 44 arranged upstream of the downstream filter 42, and downstream of the upstream filter 40. The upstream filter 40, the intermediate filter 44 and the downstream filter 42 are arranged to, in that order, filter the greywater flowing along the receiving surface 34 to the drain collector outlet 36.

The drain system 30 may further comprise an alternative drain inlet 133. The alternative drain inlet 133 is fluidly coupled to a by-pass conduit arranged to supply greywater to the sewer 79 by by-passing the heat exchanger 70. That is, the drain system 30 may be configured to instead of, or in addition to, guiding greywater via the drain collector 32 and the heat exchanger 70, guide greywater via the alternative drain inlet 133, the by-pass conduit to the sewer 79 without passing through the heat exchanger 70. Thus, in case of flooding, or in order to handle a flow of greywater exceeding the capacity of the heat exchanger 70, the drain system 30 is configured to guide the greywater to the sewer 79 via the by-pass conduit and the alternative drain inlet 133.

The drain collector 32 and the filter arrangement with the upstream filter 40, the intermediate filter 44 and the downstream filter 42 are shown in greater detail in FIG. 3. As shown in FIG. 3, the upstream filter 40 comprises a first filter screen 41 protruding from the receiving surface 34, and the intermediate filter 44 comprises a third filter screen 45 protruding from the receiving surface 34 in a corresponding manner (and same direction) as the first filter screen 41. The downstream filter 42 is in the form of a mesh 43 covering the drain collector outlet 36 (the mesh 43 is only shown in part and should be understood to at least cover the drain collector outlet 36). In more detail, each one of the first filter screen 41 and the third filter screen 45 protrudes, or extends, outwards from the receiving surface 34 in a direction along a geometrical normal to the receiving surface. However, it should be noted that each one of the first filter screen 41 and the third filter screen 45 may protrude, or extend, outwards from the receiving surface 34 in a direction which is slightly inclined relative to such geometrical normal (e.g. by up to +/−) 30°. The mesh 43 of the downstream filter 42 may be bent upwardly or downwardly (e.g. by being a bowl-, cone- or pocket shaped mesh).

The first and third filter screens 41, 45 extend vertically to the same level or above the vertical level of the inlet to the alternative drain inlet 133. In other words, the height of the first and third filter screens 41, 45 are as large or larger than the height of the vertically protruding pipe comprising the alternative drain inlet 133. Hence, in case of flooding, or in order to handle a flow of greywater exceeding the capacity of the heat exchanger 70, the greywater is guided to the sewer 79 via the by-pass conduit and the alternative drain inlet 133, while ensuring that no or a limited amount of unfiltered greywater is passed to the drain collector outlet 36 without passing the first and third filter screens 41, 45. That is, in case of flooding, unfiltered greywater cannot pass over the first and third filter screens 41, 45, in an amount that can block the heat exchanger, but will instead be guided to the alternative drain inlet 133 and the by-pass conduit to the sewer 79.

As shown in FIG. 3, each one of the upstream filter 40 and the intermediate filter 44 is a slit filter. Thus, each one of the first filter screen 41 and the third filter screen 45 comprise slits through which the greywater may pass, and posts arranged adjacent the slits for hindering greywater. Hereby, debris may be caught at the posts, or at the interface between the posts and the slits. The slit gap of the first filter screen 41 may e.g. be 3 mm and the slit gap of the third filter 45 screen 2 mm. The difference in slit gap between the first and third filter screens 41, 45 results in different filtering performances of the upstream filter 40 and the intermediate filter 44. In the embodiment of FIG. 3, each one of the first filter screen 41 and the third filter screen 45 is shaped as an annular ring (being elliptical, or at least partly elliptically shaped but with straight lateral sides).

As also shown in FIG. 3, the first filter screen 41 of the upstream filter 40 is encompassing the third filter 45 screen of the intermediate filter 44. Thus, in use, all greywater flowing along the receiving surface 34 must pass the upstream filter 40 prior to reaching the intermediate filter 44. Moreover, both the first filter screen 41 of the upstream filter 40 and the third filter screen 45 of the intermediate filter 44 are encompassing the drain collector outlet 36 and the downstream filter 42. Thus, in use, all greywater flowing along the receiving surface 34 must pass the upstream filter 40 and the intermediate filter 44 prior to reaching the drain collector outlet 36 and the downstream filter 42. As the mesh 43 is covering the drain collector outlet 36, in use, all greywater flowing along the receiving surface 34 must pass the mesh downstream filter prior reaching further downstream of the drain system 30 and to the heat exchanger 70 (shown in FIG. 2). Hereby, debris, such as textile fibers and hair, may be at least partly prevented from entering the drain collector outlet 36 and the heat exchanger 70.

Moreover, the drain system 30 in FIG. 3 comprises at least one step-wise structure forming a sand trap, here in the form of a step 35 arranged downstream of the upstream filter 40 and upstream of the downstream filter 42. The step 35 is here formed by a brim, or edge, of the intermediate filter 44 relative to the receiving surface 34b. That is, the brim or edge, which is forming a lower part of the third filter screen 45, is solid (and does not comprise a slit or opening) and thereby form a barrier for sand and other particles. As an alternative, for example in embodiments not including the intermediate filter 44, the sand trap may be formed by a step-wise structure protruding from the receiving surface 34.

According to at least one example embodiment, the upstream filter 40, the intermediate filter 44 and the downstream filter 42 are detachably arranged. For this, the receiving surface 34 comprises a first surface portion 34a arranged laterally outside of the upstream filter 40, and a second surface portion 34b arranged at least laterally inside of the upstream filter 40, wherein the upstream filter 40, the intermediate filter 44 and the downstream filter 42 are attached to the second surface portion 34b and are removably arranged relative to the first surface portion 34a. Hereby, easy and effective cleaning of the system can be performed as the upstream filter 40, the intermediate filter 44 and the downstream filter 42 can be removed together with the second surface portion 34b of the receiving surface 34 in order to remove any debris which has been caught by the upstream filter 40, the intermediate filter 44 and the downstream filter 42.

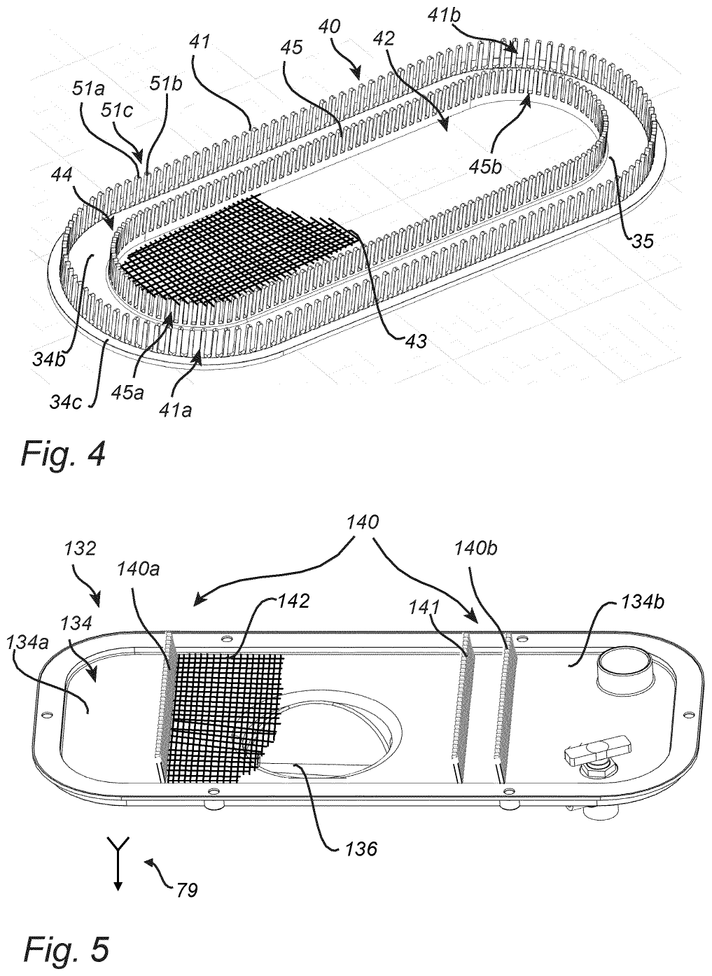

FIG. 4 shows the second surface portion 34b of the receiving surface 34, and the thereon attached upstream filter 40, intermediate filter 44 and downstream filter 42, being removed from the first surface portion 34a of the receiving surface 34. Here, the first filter screen 41 and the third filter screen 45 are shown in greater detail. Each one of the first filter screen 41 and the third filter screen 45 has an outer side 41a, 45a being arranged to face upstream, and an opposite inner side 41b, 45b arranged to face downstream. Moreover, the slits of the first and third filter screens 41, 45 are shown in greater detail. The slits through which the greywater may pass are separated by posts. As an example, a first slit 51c of the first filter screen 41 forms a slit gap between two adjacent posts 51a, 51b. Hereby, debris may be caught at the posts 51a, 51b, or at the interface between the posts 51a, 51b and the slit 51c. As shown in FIG. 4, the slits 51c of the first filter screen 41 extends along the entire height of the first filter screen 41, while the slits of the third filter screen 45 extends along a majority of the height of the third filter screen 45 (as the step 35 formed by the brim, or edge, of the lower part of the third filter screen 45 occupies a portion of the height of the third filter screen 45).

As shown in FIG. 4, the second surface portion 34b comprises a rim 34c extending laterally outside from the upstream filter 40, and the first filter screen 41. The rim 34c extends along the circumference of the first filter screen 41. Hereby, any debris which has been caught by the first filter screen 41, and which is at least partly stuck to/at the previously mentioned outer side of the first filter screen, may rest on the rim 34c and thus be removed together with the second surface portion 34b.

In FIG. 5, an alternative embodiment of a drain collector 132 is shown. The drain collector 132 may replace the drain collector 32 in any one of FIGS. 2-3, and may thus be used in the shower 1 of FIG. 1. The drain collector 132 is in large the same as the drain collector 32 in FIGS. 2-3, why mainly the differences are described. In FIG. 5, the filtering arrangement is different. In the embodiment of FIG. 5, the filtering arrangement comprises an upstream filter 140 and a downstream filter 142, the latter being e.g. the same as the downstream filter 42 in the embodiments of FIGS. 2-4. However, the upstream filter 140 comprise at least two first filter sub-screens 140a, 140b, arranged opposite each other, but still upstream of the downstream filter 142. As shown in FIG. 5, and which in principle is the same for the embodiments in FIGS. 2-3, the drain collector 132 is arranged to receive the greywater from two different and opposite directions. Thus, a receiving surface 134 of the drain collector 132 is configured to guide the greywater towards a drain collector outlet 136 (only shown symbolically) by means of two separate guide portions 134a, 134b (or guide channels 134a, 134b). Thus, a first filter sub-screen 140a of the upstream filter 140 is arranged to filter greywater flowing along a first guide portion 134a, and a second filter sub-screen 140b of the upstream filter 140 is arranged to filter greywater flowing along a second guide portion 134b. Thus, all greywater flowing over the receiving surface 134 is filtered by the upstream filter 140, by means of separate filter sub-screens 140a, 140b in the separate guide portions 134a, 134b. As an alternative, only one of the guide portions 134a, 134b is present in the receiving surface 134, and hence all greywater flowing over the receiving surface 134 is filtered by the upstream filter 140 of such guide portion (i.e. by means of one of the separate filter sub-screens 140a, 140b, whichever being present in the guide portion).

The drain collector 132 may further comprises at least one intermediate filter 141 (optional) arranged upstream of the downstream filter 142, and downstream of at least one of the two first filter sub-screens 140a, 140b. In the embodiment of FIG. 5, the intermediate filter 141 is only arranged downstream of one of the first filter sub-screen 140b. The upstream filter 140, the intermediate filter 141 and the downstream filter 142 are arranged to, in that order, filter the greywater flowing along the receiving surface 134 and the second guide portion 134b, to the drain collector outlet 136.

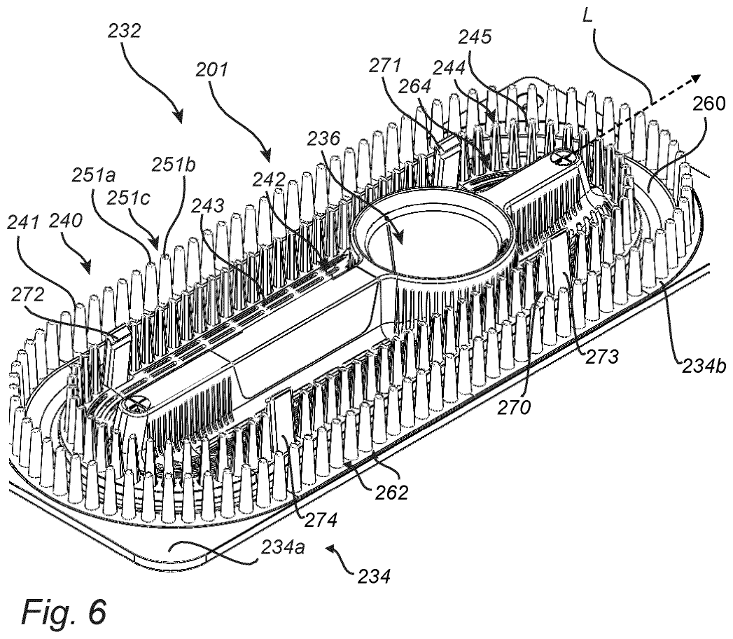

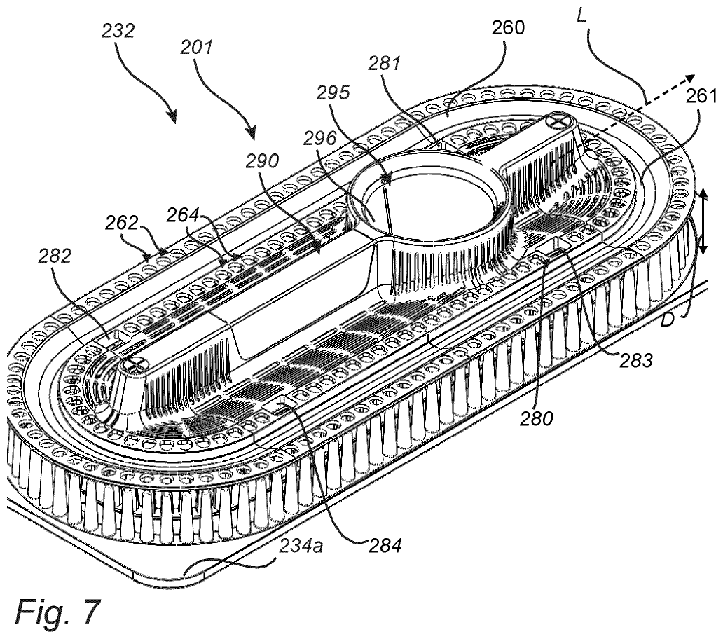

FIGS. 6-7 illustrate a filtering arrangement 201 arranged in a drain collector 232. The drain collector 232 may replace the drain collector 32 in any one of FIGS. 2-3, or the filtering arrangement 201 may replace the filter or filtering arrangement in FIG. 4, and may thus be used in the shower 1 of FIG. 1.

In FIGS. 6-7, only part of the drain collector 232 is shown, the other parts of the drain collector 232 may be the same, or largely the same, as the drain collector 32 in FIGS. 2-3, why mainly the differences are described below. The filtering arrangement 201 differs from the previously described filter or filtering arrangements mainly due to a perforated plate 260.

The filtering arrangement 201 comprises an upstream filter 240 and a downstream filter 242. As shown in FIG. 6, the upstream filter 240 comprises a first filter screen 241 protruding from the receiving surface 234, or from a first surface portion 234a of the receiving surface 234, and the downstream filter 242 comprises a second filter screen 243 in the form of a mesh or grating. The second filter screen 242 is arranged just upstream of the drain collector outlet (not shown in FIG. 6).

The 27mbodimentt of FIG. 6 also comprises an optional intermediate filter 244. The intermediate filter 244 comprises a third filter screen 245 protruding from the receiving surface 234, or from the first surface portion 234a of the receiving surface 234, in a corresponding manner (and same direction) as the first filter screen 241, as will be described later.

In more detail, the first filter screen 241 and the optional third filter screen 245, protrudes, or extends, outwards from the first surface portion 234a of the receiving surface 234 in a direction along a geometrical normal to the receiving surface 234. As shown in FIG. 6, each one of the upstream filter 240 and the optional intermediate filter 244 is a slit filter. Thus, each one of the first filter screen 241 and the third filter screen 245 comprises slits through which the greywater may pass, and posts arranged adjacent the slits for hindering debris in the greywater. As an example, a first slit 251c of the first filter screen 241 forms a slit gap between two adjacent posts 251a, 251b. Hereby, debris may be caught at the posts 251a, 251b, or at the interface between the posts 251a, 251b and the slit 251c. The slit gap of the first filter screen 241 may e.g. be 3 mm and the slit gap of the third filter 245 screen 2 mm. The difference in slit gap between the first and third filter screens 241, 245 results in different filtering performances of the upstream filter 240 and the intermediate filter 244. In the embodiment of FIG. 6, each one of the first filter screen 241 and the third filter screen 245 is shaped as an annular ring (being elliptical, or at least partly elliptically shaped but with straight lateral sides) in which the first filter screen 241 surrounds the third filter screen 245.

The perforated plate 260 in the embodiment of FIGS. 6-7 comprises the second filter screen 243. Moreover, the perforated plate 260 comprises a first set of plurality of perforations 262 for guiding the first filter screen 241. Furthermore, the perforated plate 260 may comprise an optional second set of plurality of perforations 264 for guiding the optional third filter screen 245. Hereby, the perforated plate 260 may move relative to the first filter screen 241, and the optional third filter screen 245, as the posts 251a, 251b of the first filter screen 241 run through the first set of plurality of perforations 262, and the posts of the third filter screen 243 run through the second set of plurality of perforations 264.

As shown in FIG. 6, the receiving surface 234 comprises the first surface portion 234a mentioned above, and from which the first filter screen 241 and the optional third filter screen 245 protrude. That is, the posts of the first and third filter screens 241, 243 protrude from the first surface portion 234a. Moreover, the receiving surface 234 comprises a second surface portion 234b which is formed by the perforated plate 260. The second surface portion 234b of the receiving surface 234, or the perforated plate 260, is removably arranged on top of the first surface portion 234a of the receiving surface 234. Thus, the first filter screen 241, or the posts 251a, 251b of the first filter screen 241, are attached to the first surface portion 234a of the receiving surface 234 from which they protrude. Owing to the first set of plurality of perforations 262, through which the posts 251a, 251b run (or protrude) and to the second set of plurality of perforations 264, through which the posts of the third filter screen 245 run (or protrude), the perforated plate 260 may be arranged on top of the first surface portion 234a of the receiving surface 234, and may vertically move in relation to the first surface portion 234. Vertical movement is here referring to a direction perpendicular to the first surface portion 234a of the receiving surface 234. In other words, the first filter screen 241 may be described as protruding from the first surface portion 234a and through the perforated plate 260. Correspondingly, the third filter screen 245 may be described as protruding from the first surface portion 234a and through the perforated plate 260.

In more detail, the perforated plate 260 is configured to be moved, e.g. vertically moved, from a first position in which the perforated plate 260 rests on the first surface portion 234a of the receiving surface 234, into a second position in which the perforated plate 260 is vertically distant from the first surface portion receiving surface 234 by a predetermined distance D, as shown in FIG. 7. Hereby, debris which have been caught at the posts, or at the interface between the posts and the slits in the first filter screen 241 and the third filter screen 245 may be efficiently removed from the perforated plate 260. That is, in the second position of the perforated plate 260, shown in FIG. 7, the perforated plate 260 is vertically distant from the first surface portion 234a of the receiving surface 234 and therefore more accessible for cleaning. As shown in FIG. 6, the slits 251c of the first filter screen 241 extends along the entire height of the first filter screen 241, and the slits of the optional third filter screen 245 extends the entire height of the third filter screen 245. Hereby, the perforated plate 260 can easily be moved vertically from the first position to the second position.

The plurality of posts 251a, 251b of the first filter screen 241, as well as the corresponding posts of the optional third filter screen 245, preferably have a common predetermined height. The previously mentioned predetermined distance D which extends between an upper surface 261 of the perforated plate and the first surface portion 234a of the receiving surface 234 is at least the same, e.g. substantially the same, as the predetermined height of the posts. Hereby, in the second position of the perforated plate 260, the posts 251a, 251b will not protrude through the perforations 262, 264 of the perforated plate 260. Hereby, the upper surface 261, or at least the part of the upper surface 261 comprising the first and second sets of plurality of perforations 262, 264, of the perforated plate 260, will be easy to clean.

As shown in FIGS. 6-7, the perforated plate 260 may be locked in the second position by a first locking structure 270 and a second locking structure 280. The first locking structure 270 is exemplified by four protruding arms 271, 272, 273, 274. The second locking structure 280 is exemplified by four corresponding locking surfaces 281, 282, 283, 284. Each of the four locking arms 271, 272, 273, 274 comprises a locking brim which is configured to lock to the locking surfaces 281, 282, 283, 284 in the second position of the perforated plate 260, e.g. by a snap-fit connection.

The perforated plate 260 may comprises a ridge-like structure 290 extending along a length L of the perforated plate 260. The ridge-like structure 290 may e.g. be arranged radially inside of the second filter screen 243. As seen in FIG. 7, the ridge-like structure 290 may comprise an opening 295 arranged along the ridge-like structure 290. The opening 295 is typically aligned with the drain collector outlet (not shown). Hereby, the drain collector outlet may be accessed in an advantageous manner, e.g. for receiving cleaning material, or cleaning granulates. Typically, the opening 295 is defined by inner walls 296 extending into the ridge like structure 290.

In use, the greywater may flow along the first surface portion 234a and further to the second surface portion 234b or the perforated plate 260, and be filtered by the first filter screen 241 prior to reaching the third filter screen 245 and thereafter the second filter screen 243 of the perforated plate 260. After being filtered by the second filter screen 243, the greywater reached the drain collector outlet (i.e. not via opening 295, but by the second filter screen 243 and to an underside of the perforate plate 260). Thus, there may be a gap between the first surface portion 234a of the receiving surface 234 and the underside of the perforated plate 260, at least below the second filter screen 234 and up to the drain collector outlet. As an alternative, the drain collector outlet is arranged directly downstream of the second filter screen, such that after the greywater has passed the second filter screen, it is received by the drain collector outlet, e.g. by a collecting surface of the drain collector outlet. Such collecting surface may be a sloped surface.

Turning back to FIG. 1, the plate 7 may guide the greywater, such all of the greywater, to a receiving surface by the punched holes 9a as previously described. However, the plate 7 may comprise secondary holes or openings, e.g. arranged inside of the punched holes 9a. Hereby, at least some greywater, such as a minority of the greywater, may be guided to a mid-portion of the receiving surface, e.g. the previously mentioned second surface portion, or be directly guided to the downstream filter. For example, as greywater falls from the secondary holes or openings of the plate 7 directly onto the downstream filter, the impacting of the greywater onto the second filter screen may have a cleansing effect.

Even though the invention has been described with reference to specific exemplifying embodiments thereof, many different alterations, modifications and the like will become apparent for those skilled in the art. For example, the drain system may be installed for heat recovery of greywater from a faucet, or a bathtub, instead of a shower. Moreover, more intermediate filters may be arranged between the upstream filter and the downstream filter. Moreover, the first filter screen and/or the third filter screen need not to be slit filter, but may comprise openings or apertures through which the greywater may pass. The holes or apertures may e.g. be rectangularly shaped. Moreover, the drain system described herein is applicable for a shower tray (i.e. a shower cabin without the walls). The intermediate filter 244 and the third filter screen 245 mentioned for the embodiment in FIGS. 6-7 are optional and may be excluded from the embodiment. Thus, corresponding structure, as the second set of plurality of apertures 264, is optional and may be excluded from the embodiment.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A drain system for recovering thermal energy from a flow of shower or faucet greywater, the system comprising:
a drain collector having a receiving surface for receiving greywater, and a drain collector outlet formed in the receiving surface for discharging greywater from the receiving surface,
a heat exchanger arranged downstream of the drain collector outlet and comprising a grey water inlet and grey water outlet, the heat exchanger being configured to heat a flow of incoming cold water with the greywater flowing from the grey water inlet to the grey water outlet,
an upstream filter and a downstream filter, arranged to filter the greywater flowing along the receiving surface to the drain collector outlet, wherein the upstream filter comprises a first filter screen protruding from the receiving surface and the downstream filter comprises a second filter screen arranged upstream the drain collector outlet.

2. The drain system according to claim 1, wherein the second filter screen of the downstream filter is a mesh covering the drain collector outlet.

3. The drain system according to claim 1, further comprising an intermediate filter arranged downstream of the upstream filter and upstream of the downstream filter, the intermediate filter comprising a third filter screen protruding from the receiving surface correspondingly to the first filter screen of the upstream filter.

4. The drain system according to claim 1, wherein the first filter screen of the upstream filter is arranged to encompass the drain collector outlet and the downstream filter.

5. The drain system according to claim 3, wherein the first filter screen of the upstream filter is encompassing the third filter screen of the intermediate filter.

6. The drain system according to claim 5, wherein each one of the first and third filter screens is shaped as an elliptical ring, or an annular ring.

7. The drain system according to claim 1, wherein the first filter screen of the upstream filter has an outer side facing upstream to receive greywater, and an opposite inner side facing downstream.

8. The drain system according to claim 1, wherein the upstream filter and the downstream filter has different filtering performances.

9. The drain system according to claim 1, wherein the upstream filter is a slit filter.

10. The drain system according to claim 1, comprising a step-wise structure protruding from the receiving surface and being arranged downstream of the upstream filter and upstream of the downstream filter to form a sand trap.

11. The drain system according to claim 1, wherein the receiving surface comprises a first surface portion arranged laterally outside of the upstream filter, and a second surface portion arranged at least laterally inside of the upstream filter, wherein the upstream filter and the downstream filter are attached to the second surface portion and are removably arranged relative to the first surface portion.

12. The drain system according to claim 11, wherein a rim of the second surface portion extends laterally outside from the upstream filter, the rim being arranged to extend along the upstream filter.

13. The drain system according to claim 1, further comprising an alternative drain inlet fluidly coupled to a by-pass conduit arranged to by-pass the heat exchanger.

14. The drain system according to claim 13, wherein the first filter screen of the upstream filter extend vertically to the same level or above the vertical level of the alternative drain inlet.

15. The drain system according to claim 1, further comprising a perforated plate comprising the second filter screen, the perforated plate comprising a plurality of perforations for guiding the first filter screen.

16. The drain system according to claim 15, wherein the receiving surface comprises a first surface portion from which the first filter screen protrudes, and a second surface portion formed by the perforated plate and being removably arranged on top of the first surface portion.

17. The drain system according to claim 16, wherein the perforated plate is configured to be moved from a first position in which the perforated plate rests on the first surface portion of the receiving surface, into a second position in which the perforated plate is vertically distant from the first surface portion receiving surface by a predetermined distance.

18. The drain system according to claim 15, wherein the first filter screen is a slit filter comprising a plurality of posts in between the slits, and wherein each perforation in the plurality of perforations is configured to guide a corresponding post of the slit filter.

19. The drain system according to claim 17, wherein the plurality of posts has a predetermined height, and wherein the predetermined distance is at least the same as the predetermined height.

20. The drain system according to claim 17, further comprising a first locking structure, wherein the perforated plate comprises a second locking structure, and wherein the perforated plate is configured to be locked in the second position by that the second locking structure lock to the first locking structure.

21. The drain system according to claim 15, wherein the perforated plate comprises a ridge like structure extending along a length of the perforated plate, and an opening arranged along the ridge like structure, wherein the opening is aligned with the drain collector outlet.

22. A shower or shower cabin comprising:
a shower arrangement having a shower mixer configured to mix hot water from a hot water supply and pre-heated cold water from a cold water supply, and a shower head fluidly connected to the shower mixer for supplying shower water;
a drain system according to claim 1.

23. The shower or shower cabin according to claim 22, wherein the heat exchanger of the drain system is configured to heat a flow of incoming cold water with the greywater flowing from the grey water inlet to the grey water outlet, to provide the cold water as the pre-heated cold water of the shower arrangement.
